(19) United States
(12) Patent Application Publication
(10) Pub. No.: US 2006/0078247 A1
(43) Pub. Date: Apr. 13, 2006

(54) Package structure for optical modulator

(75) Inventors: Yeong Gyu Lee, Gyeonggi-do (KR); Jong Hyeong Song, Gyeonggi-do (KR); Heung Woo Park, Seoul (KR); Suk Kee Hong, Seoul (KR); Chang Su Park, Gyeonggi-do (KR); Ohk Kun Lim, Gyeonggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 11/244,563

(22) Filed: Oct. 6, 2005

(30) Foreign Application Priority Data
Oct. 8, 2004 (KR) 2004-80503

(51) Int. Cl. G02B 6/12

(52) U.S. Cl. 385/14

(57) ABSTRACT

Disclosed herein is a package structure for an optical modulator, which is configured such that an optical modulating device and electronic control circuitry are incorporated into a module, thus allowing the manufacture of a compact module while maintaining the optical properties of the optical modulating device.

### BACKGROUND OF THE INVENTION

1. Field of the Invention

The present invention relates generally to a package structure for an optical modulator and, more particularly, to a package structure for an optical modulator, which allows the manufacture of a compact module while maintaining the optical properties of an optical modulating device.

2. Description of the Related Art

As the Internet and mobile phones have become popular, the information age is rapidly arriving, and the amount of information is dramatically increasing. Further, the construction of infrastructure for information systems is becoming a matter of primary concern of a national undertaking.

This inevitably requires the communication and storage of information. The affordability, miniaturization, high-capacity, and digitization of information and communication devices, information displays, and recording devices have been achieved. Faster data transmission and storage of a greater amount of data in a limited space are required. Further, the market demand for products increasing a user's convenience and mobility is continuously growing.

Meanwhile, a micromachining technology has been developed, which manufactures micro-optical parts including a micromirror, a micro lens, and a switch, a micro inertia sensor, a micro biochip, and a micro wireless communication device, using a semiconductor device manufacturing process.

Further, MEMS designating the micromachining technology, devices and systems manufactured by the micromachining technology have been established as an independent manufacturing technology and application field.

The MEMS are called micro-electro-mechanical systems or devices, and are applied to an optical field. When using the micromachining technology, it is possible to manufacture an optical part smaller than 1 mm. Thereby, a micro-optical system can be attained. A separately manufactured semiconductor laser is mounted on a holder which is manufactured through the micromachining technology, and a micro Fresnel lens, a beam splitter, and a reflecting mirror are manufactured through the micromachining technology and subsequently assembled. A conventional optical system is configured such that the mirror, the lens, etc. are mounted on a large and heavy optical bench using an assembling tool. The laser is also large in size. In order to obtain desired performance of the optical system configured as described above, a precise stage and much effort are required to arrange an optical axis, a reflecting angle, a reflective surface, etc.

However, the micro optical system is advantageous in that it reduces the tools, space, and effort required, in addition to achieving performance different from that of the conventional optical system.

The micro optical system has several advantages, that is, fast response speed, reduced light loss, and easy integration and digitization. Due to such advantages, the micro optical system is adapted and applied to information and communication devices, information displays, and recording devices.

For example, micro-optical parts, such as a micromirror, a micro lens, and an optical fiber holder, may be applied to a data storage recording device, a large image display, an optical communication device, and adaptive optics.

In this case, the application of the micromirror varies according to the moving direction of the micromirror, including a vertical direction, a tilt direction, and a sliding direction, and the type of movement of the micromirror, including a dynamic movement and a static movement. The vertical movement of the micromirror is used in a phase equalizer, a diffractor, etc. The tilt movement of the micromirror is used in a scanner, a switch, an optical signal distributor, an optical signal attenuator, a light source array, etc. Further, the sliding movement of the micromirror is used in a light interrupter, a switch, an optical signal distributor, etc.

The micromirror is manufactured such that it is about 10˜1000 μm in size, and is about 1˜10⁶ in number. The micromirror applied to the large image display is about 10˜50 μm in size and is small. But, as many mirrors as pixels are needed, so that about one million mirrors are required. In the case of the adaptive optics or optical signal distributor, the size of the mirror is hundreds of micrometers (μm) and is relatively large. However, the required number of mirrors is reduced, so that several hundreds of mirrors are required. Meanwhile, in the case of the scanner or optical pickup device, the mirror is several millimeters and is large. Thus, one mirror may be used in the scanner or optical pickup device. As such, the size and number of mirrors are different according to the application purposes, and the mirrors are differently applied according to the moving direction and the dynamic or static movement thereof. Of course, the method of manufacturing the micromirror becomes different according to the application purpose. The mirror of the large image display is several tens of micrometers in size, and is several tens of microseconds (μs) in response speed. The response speed is considerably fast. Meanwhile, the mirror of the adaptive optics or the optical signal distributor is several hundreds of micrometers in size, and is several hundreds of microseconds in response speed. Further, the mirror having a size of several millimeters (mm) is used for the scanner or the like, and the response speed of the mirror is several microseconds.

At present, the micromirror is applied to a large image display, an optical signal distributor, a barcode scanner, and an optical signal attenuator. Research has been conducted into the commercialization of the micromirror.

Meanwhile, the demand for a large image has been continuously increased. Meeting participants or visitors are impressed by pictures, photographs, or dynamic images having brilliant colors at various meetings or exhibitions. As the large image display has appeared, many people may simultaneously participate in a meeting and see a large image in a place sufficiently lighted to allow the people to look at paper on their desks.

Currently, most large image displays (e.g. projectors) use liquid crystals as optical switches. Such projectors are smaller in size, cheaper, and have simpler optical systems, in comparison with conventional CRT projectors. However, the projectors are disadvantageous in that light passes from a light source to a liquid crystal plate, and is radiated onto a screen, so that light loss is large.

Recently, light efficiency has improved but a reduction in efficiency unavoidably occurs during the transmission of light. In order to enhance light efficiency and obtain a more distinct image, a device for displaying a large image using the micromirror has been produced and introduced to the market.

Micromirrors, having sizes of several tens of micrometers, are manufactured in the same number as the number of pixels of an image, and the micromirrors are individually driven, thus forming the image. Nowadays, a projector for a lecture or conference utilizes liquid crystals. The projector using the liquid crystal display has a problem in that light must pass through the liquid crystal plate, so that light loss is large. Conversely, the projector using the micromirrors utilizes reflection, so that light loss is small. Thus, assuming that the same input light source is used, the projector using the micromirrors achieves a brighter image.

The micromirror is driven in response to a digital signal. Such a drive method corresponds to a current image processing trend that processes an image in response to a digital signal. It may be applied to a projector for a lecture, conference, home, or small theater. Particularly, in the case of a movie, scenes are filmed using a digital camera for convenient editing, distribution, and storage. Thus, the micromirror is used for the projector for a small theater.

The micromirror is embodied by a reflective deformable grating optical modulator 10 as shown in FIG. 1. The modulator 10 is disclosed in U.S. Pat. No. 5,311,360 by Bloom et al. The modulator 10 includes a plurality of reflective deformable ribbons 18, which have reflective surface parts, are suspended on an upper part of a silicon substrate 16, and are spaced apart from each other at regular intervals. An insulating layer 11 is deposited on the silicon substrate 16. Subsequently, a sacrificial silicon dioxide film 12 and a low-stress silicon nitride film 14 are deposited.

The nitride film 14 is patterned by the ribbons 18, and a portion of the silicon dioxide film 12 is etched, thereby maintaining the ribbons 18 on the oxide spacer layer 12 by a nitride frame 20.

In order to modulate light having a single wavelength of λₒ, the modulator is designed so that the thickness difference between the ribbon 18 and oxide spacer 12 is equal to a multiple of λₒ/2.

Limited by a vertical distance between a reflective surface 22 of each ribbon 18 and a reflective surface of the substrate 16, a grating amplitude of the modulator 10 is controlled by applying voltage between the ribbon 18 (the reflective surface 22 of the ribbon 18 acting as a first electrode) and the substrate 16 (a conductive layer 24 formed on a lower side of the substrate 16 to act as a second electrode).

However, the optical modulator of Bloom uses an electrostatic manner to control the position of the micromirror. In this case, the optical modulator is problematic in that an operating voltage is relatively high (about 30V or so), and the relation between applied voltage and displacement is nonlinear. Consequently, such an optical modulator cannot reliably control light.

In order to solve the problem, U.S. patent application Ser. No. 10/952,556 is disclosed, which is titled “thin-film piezoelectric optical modulator and manufacturing method thereof”.

FIG. 2 is a cross-sectional view of a recess-type thin-film piezoelectric optical modulator according to a conventional technology.

Referring to FIG. 2, the recess-type thin-film piezoelectric optical modulator according to the conventional technology includes a silicon substrate 101 and components 110.

In this regard, the components 110, which have predetermined widths and are arranged at regular intervals, constitute the recess-type thin-film piezoelectric optical modulator. Additionally, the components 110 may be spaced apart from each other at regular intervals (each interval is almost the same as the width of each component 110), in which a micromirror layer formed on an upper side of the silicon substrate 101 reflects incident light to diffract it.

The silicon substrate 101 has a recess to provide an air space to each component 110, an insulating layer 102 is deposited on an upper surface of the substrate, and ends of the components 110 are attached to upper sides of a wall of the recess.

The components 110 each have a rod shape, and lower sides of ends of the components are attached to the remaining upper side of the substrate 101 except for the recess so that the centers of the components are spaced from the recess of the silicon substrate 101. Additionally, each component 110 includes a lower supporter 111 which has a vertically movable portion corresponding in position to the recess of the silicon substrate 101.

Furthermore, the component 110 is layered on a left end of the lower supporter 111, and includes a lower electrode layer 112 for providing a piezoelectric voltage, a piezoelectric material layer 113 which is layered on the lower electrode layer 112 and shrinks or expands when a voltage is applied to both sides thereof to generate upward or downward driving forces, and an upper electrode layer 114 which is layered on the piezoelectric material layer 113 and provides a piezoelectric voltage to the piezoelectric material layer 113.

Furthermore, the component 110 is layered on a right end of the lower supporter 111, and includes a lower electrode layer 112′ for providing a piezoelectric voltage, a piezoelectric material layer 113′ which is layered on the lower electrode layer 112′ and shrinks and expands when a voltage is applied to both sides thereof to generate upward or downward driving forces, and an upper electrode layer 114′ which is layered on the piezoelectric material layer 113′ and provides a piezoelectric voltage to the piezoelectric material layer 113′.

Additionally, U.S. patent application Ser. No. 10/952,556 describes an extrusion type as well as the recess type in detail.

Meanwhile, in order to manufacture a modulator, disclosed in U.S. patent application Ser. No. 10/952,556, as a product, it is required to modularize the optical modulator. When modularizing the optical modulator, several characteristics must be considered.

Generally, a conventional diffracted optical modulator has been manufactured in a hybrid form, that is, electronic control circuitry is not integrated into the same die but is manufactured on another substrate. The optical modulator modularized in the hybrid form has advantageous yields and cost.

Further, since the optical modulating device utilizes light in a manner different from a general device, it is impossible to use an existing modular structure or modularizing process. Many modifications in the existing modular structure or modularizing process are required. The optical modulating device is not resistant to moisture due to the operational structure of an active device, so that the optical modulating device must be hermetically sealed. In order to provide stable operation and increase the life span of the device, the device must be designed such that heat generated by the radiation of light and the operation of the device is efficiently dissipated. Further, it is advantageous in that an integrated device for driving the optical modulating device is integrated into the optical modulating device or installed in the same housing so as to provide a compact module and allow easy signal connection.

### SUMMARY OF THE INVENTION

Accordingly, the present invention has been made keeping in mind the above problems occurring in the prior art, and an object of the present invention is to provide a package structure for an optical modulator, which is configured such that an optical modulating device and electronic control circuitry are incorporated into a module, thus allowing the manufacture of a compact module while maintaining the optical properties of the optical modulating device.

In order to accomplish the above object, the present invention provides a package structure for an optical modulator, including a transparent substrate; an optical modulating device disposed on the transparent substrate; electronic circuitry for controlling the optical modulating device, the electronic circuitry being disposed on the transparent substrate; a printed circuit board on which the transparent substrate is disposed, the printed circuit board being configured to permit light to pass into the package structure to the optical modulating device and to permit light to pass from the optical modulating device out though the package structure; and an electrical connection system electrically interconnecting the optical modulating device, the electronic control circuitry, and the printed circuit board.

Further, the present invention provides a package structure for an optical modulator, including a transparent substrate; an optical modulating device disposed on the transparent substrate; electronic circuitry for controlling the optical modulating device, the electronic circuitry disposed on the transparent substrate; and an electrical connection system extending between the optical modulating device and the electronic control circuitry, the electrical connection system incorporated into the structure of the transparent substrate.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a grating optical modulator adopting an electrostatic manner according to a conventional technology;

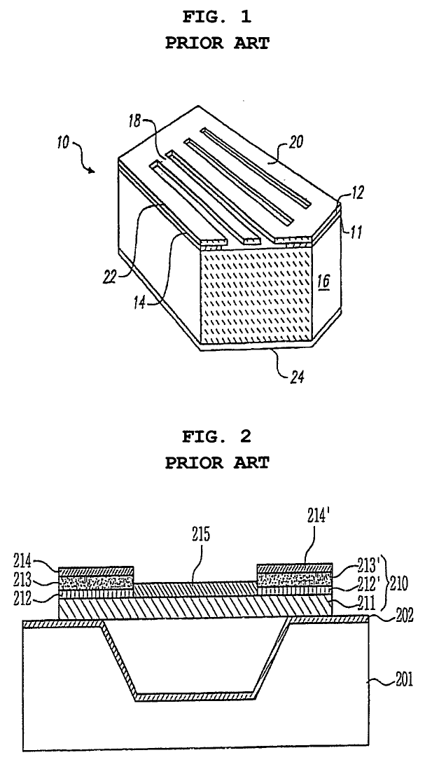

FIG. 2 is a side sectional view of a diffraction-type thin-film piezoelectric micromirror having a recess, according to a conventional technology;

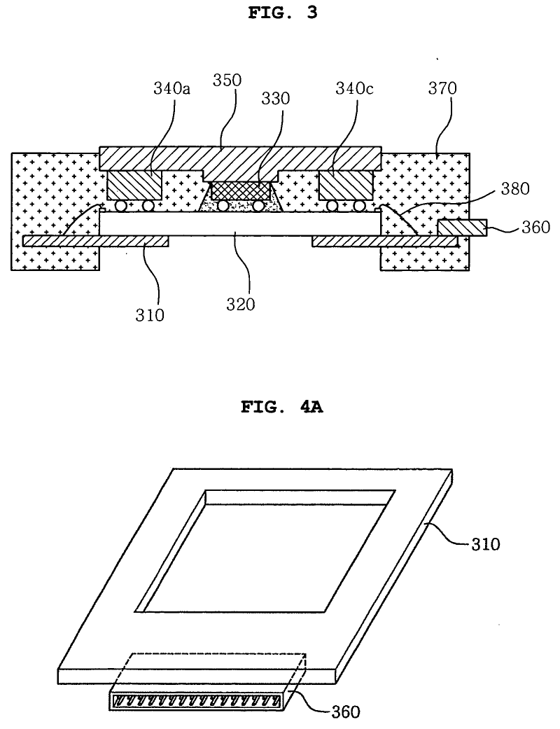

FIG. 3 is a sectional view of a package structure for an optical modulator, according to the first embodiment of the present invention;

FIGS. 4A to 4C are perspective views of the package structure for the optical modulator, according to the first embodiment of this invention;

FIG. 5 is a plan view to show an electrical connection system provided on a transparent substrate shown in FIG. 3;

FIG. 6 is a sectional view of a package structure for an optical modulator, according to the second embodiment of this invention;

FIGS. 7A and 7B are perspective views of the package structure for the optical modulator, according to the second embodiment of this invention;

FIGS. 8A and 8B are plan views to illustrate the wiring of the transparent substrate of FIG. 3; and

FIGS. 8C and 8D are sectional views to illustrate the wiring of the transparent substrate of FIG. 3.

### DESCRIPTION OF THE PREFERRED EMBODIMENTS

The preferred embodiment of the present invention will be described below in detail with reference to the accompanying drawings.

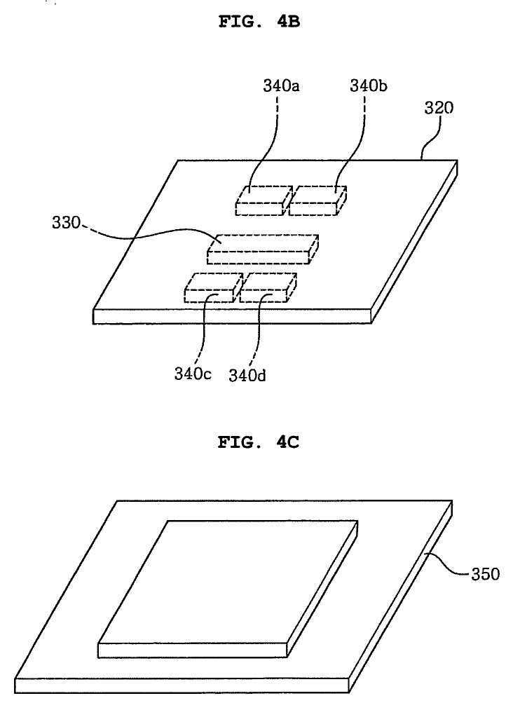

FIG. 3 is a sectional view of a package structure for an optical modulator, according to the preferred embodiment of the present invention.

Referring to the drawing, the package structure for the optical modulator according to this invention includes a printed circuit board (PCB) 310, a transparent substrate 320, an optical modulating device 330, electronic control circuits 340a to 340d (since FIG. 3 is a sectional view, only 340a and 340c are shown in FIG. 3), a heat conductive plate 350, a connector 360, and molding 370.

The PCB 310 has connection circuitry therein, which may be referred to as an electrical connection system, thus transmitting a control signal, input from external control circuitry through the connector 360, to the electronic control circuits 340a to 340d. The PCB 310 is electrically connected to the electronic control circuits 340a to 340d through wire bonding 380.

Further, an opening is provided in the PCB 310 to allow light to pass therethrough to the optical modulating device 330. The connector (external electrical connector) 360 is provided at a predetermined position on the PCB 310 and is in electrical communication with the external control circuitry. The connector 360 (external electrical connector) 360 is attached to a surface of the PCB 320 using an adhesive or the like.

It is preferable that the transparent substrate 320 be coated with an anti-reflection coating film to reduce undesired reflections.

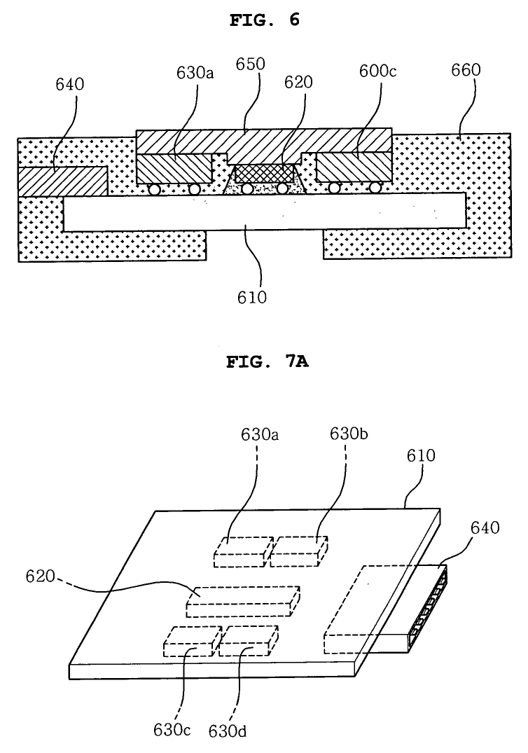

The optical modulating device 330 is connected to the center of the surface of the transparent substrate 320 by a flip-chip connection. An adhesive, such as an epoxy compound, is provided around the optical modulating device 330 to isolate the optical modulating device 330 from an external environment. Further, portions of the transparent substrate 320 other than the opening are coated with a black color, thus preventing the undesired transmission of light. FIG. 5 is a plan view to show the electrical connection system provided on the transparent substrate 320. The optical modulating device 330 is connected to pads Pa and Pa′ by a flip-chip connection. Further, the connection pad Pa is electrically connected through a signal line S1 to a second connection pad Pb provided on a left side. Further, the right connection pad Pa′ is electrically connected through a signal line S1′ to a second connection pad Pb′ provided on a right side.

Further, the electronic control circuits 340a to 340d are connected to portions around the optical modulating device 330, which is attached to the transparent substrate 320, through flip-chip connection. The optical modulating device 330 and the electronic control circuits 340a to 340d maintain electrical connection due to the wiring (referred to as an electrical connection system), which is formed along the surface of the transparent substrate 320. The flip-chip connection of the electronic control circuits 340a to 340d is realized through pads Pb and Pc and Pb′ and Pc′. In this case, the left connection pad Pc is connected via a signal line S2 to a wire bonding pad Pd, and the right connection pad Pc′ is connected via a signal line S2′ to a right wire bonding pad Pd′. The wire bonding pads Pd and Pd′ are used for a wire bonding connection 380.

Next, the heat conductive plate 350 is disposed in heat transmission relationship to the optical modulating device 330 and the electronic control circuits 340a to 340d. The heat conductive plate 350 is made of a material that efficiently conducts heat.

Meanwhile, as described above, the PCB 310, the transparent substrate 320 having the optical modulating device 330 and the electronic control circuits 340a to 340d, and the heat conductive plate 350 are layered, and thereafter molding is performed, thus securely supporting the components and protecting the components from external impact.

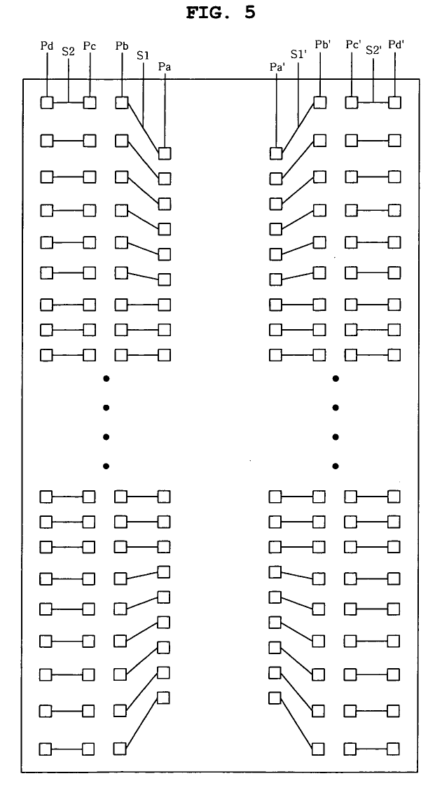

FIGS. 4A to 4C are perspective views of the package structure for the optical modulator, according to the preferred embodiment of this invention.

Referring to FIG. 4A, in the package structure for the optical modulator according to the preferred embodiment of this invention, the PCB 310 has an electric circuit which may be called an electrical connection system, thus transmitting a control signal input through the connector 340 to the electronic control circuits 340a to 340d.

A rectangular opening is provided in the center of the PCB 310, so that light passes through the rectangular opening to the optical modulating device 330.

The connector (external electrical connector) 360 is connected to an end of the PCB 310 so that a control signal is input from an external control circuit to the PCB 310.

The connector 360 is attached to the PCB 310. Thereafter, the connector 360 is firmly secured through the molding 370. According to this embodiment, the molding 370 is used as a housing, but other casings may be used as the housing.

Referring to FIG. 4B, the transparent substrate 320 according to the preferred embodiment of this invention is made of a light transmissive material, and the optical modulating device 330 is attached to a back surface of the transparent substrate 320. Further, the electronic control circuits 340a to 340d are attached to portions around the optical modulating device 330. As shown in the drawings, the optical modulating device 330 has a cross-section of a rectangle, two sides of which are longer than the remaining sides. The electronic control circuits 340a to 340d each have a rectangular cross-section, and are smaller than the optical modulating device 330. In this case, the number of electronic control circuits may be increased or reduced as necessary.

An upper surface of the transparent substrate 320 is coated with an absorbent foil or a scattering foil to absorb light, thus preventing incident light from being irregularly reflected on the upper surface. A metal colored black may be utilized as the absorbent foil or scattering foil.

Referring to FIG. 4C, the upper surface of the heat conductive plate 350 according to the preferred embodiment of this invention contacts the optical modulating device 330. Further, a flat portion is provided on the heat conductive plate 350 so that the electronic control circuits 340a to 340d may be attached to the flat portion.

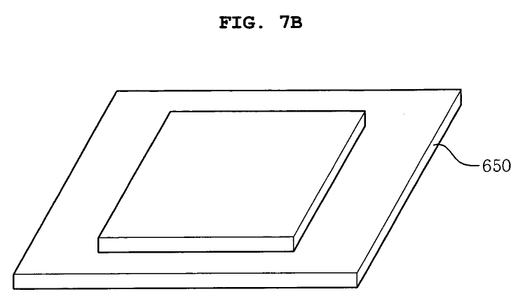

FIG. 6 is a sectional view of a package structure for an optical modulator, according to the second embodiment of the present invention.

Referring to the drawing, the package structure for the optical modulator according to the preferred embodiment of this invention includes a transparent substrate 610, an optical modulating device 620, electronic control circuits 630a to 630d (since FIG. 3 is a sectional view, only 630a and 630c are shown in FIG. 3), a connector 640 (external electrical connector), a heat conductive plate 650, and molding 660.

It is preferable that the transparent substrate 610 be coated with an anti-reflection coating film to reduce undesired reflections.

The optical modulating device 620 is connected to the center of the surface of the transparent substrate 610 by a flip-chip connection. An adhesive, such as an epoxy compound, is provided around the optical modulating device 620 to isolate the optical modulating device 620 from an external environment. Further, portions of the transparent substrate 610 other than the opening are coated with a black color, thus preventing the undesired transmission of light.

Further, the electronic control circuits 630a to 630d are connected to portions around the optical modulating device 620, which is attached to the transparent substrate 610, through flip-chip connection. The optical modulating device 620 and the electronic control circuits 630a to 630d maintain electrical connection due to the wiring (referred to as an electrical connection system), which is formed along the surface of the transparent substrate 610.

Next, the heat conductive plate 650 is provided to dissipate heat generated from the optical modulating device 620 and the electronic control circuits 630a to 630d, and is made of a material that efficiently dissipates heat.

The connector 640 is connected to an end of the transparent substrate 610. A control signal is input from an external control circuit to the connector 640, and thereafter is transmitted through the wiring (referred to as an electrical connection system) formed in the transparent substrate 610 to the electronic control circuits 630a to 630d.

Meanwhile, as described above, the transparent substrate 610, having the optical modulating device 620, the electronic control circuits 630a to 630d, and the connector 640 is layered on the heat conductive plate 650, and thereafter molding is performed, thus securely supporting the components and protecting the components from external impact.

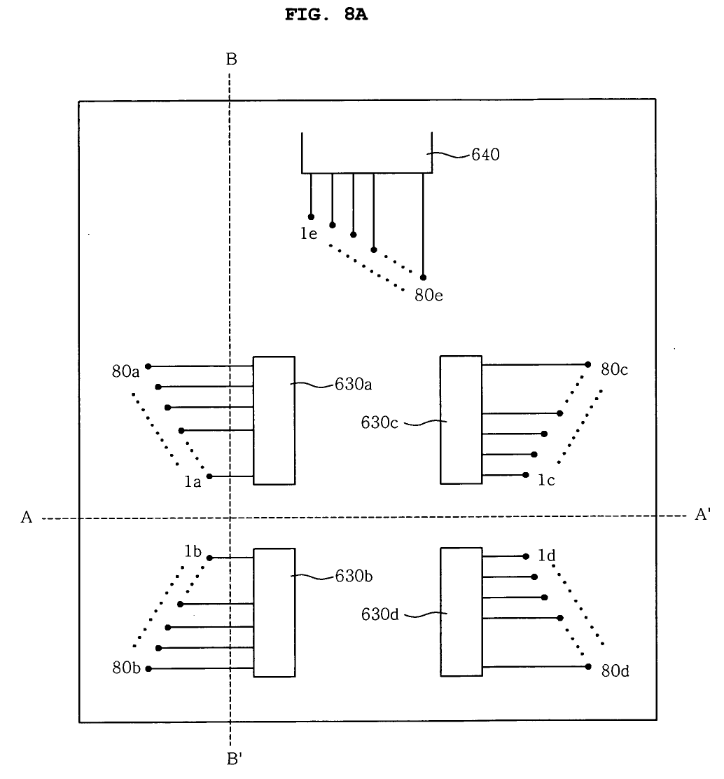

FIGS. 7A and 7B are perspective views of the package structure for the optical modulator, according to the second embodiment of this invention.

Referring to FIG. 7A, in the package structure for the optical modulator according to the second embodiment of this invention, the transparent substrate 610 is made of a light transmissive material, and the optical modulating device 620 is attached to a back surface of the transparent substrate 610. Further, the electronic control circuits 630a to 630d are attached to portions around the optical modulating device 620.

As shown in the drawings, the optical modulating device 620 has a cross-section of a rectangle, two sides of which are longer than the remaining sides. The electronic control circuits 630a to 630d each have a rectangular cross-section. In this case, the number of electronic control circuits 630a to 630d may be increased or reduced as necessary. An upper surface of the transparent substrate 610 is coated with an absorbent foil or a scattering foil to absorb light, thus preventing incident light from being irregularly reflected on the upper surface.

The transparent substrate 610 has an electric circuit (referred to as an electrical connection system) therein, and transmits a control signal, input via the connector 640, to the electronic control circuits 630a to 630d.

The connector 640 is connected to an end of the transparent substrate 610 so that a control signal is input from an external control circuit to the transparent substrate 610.

The connector 640 is attached to the transparent substrate 610. Thereafter, the connector 640 is firmly secured through the molding 660. According to this embodiment, the molding 660 is used as a housing, but other casings may be used as the housing.

Referring to FIG. 7B, a portion of the heat conductive plate 650 according to the second embodiment of this invention contacts the optical modulating device 620. Further, a flat portion is provided on the heat conductive plate 650 so that electronic control circuits 630a to 630d are attached to the flat portion.

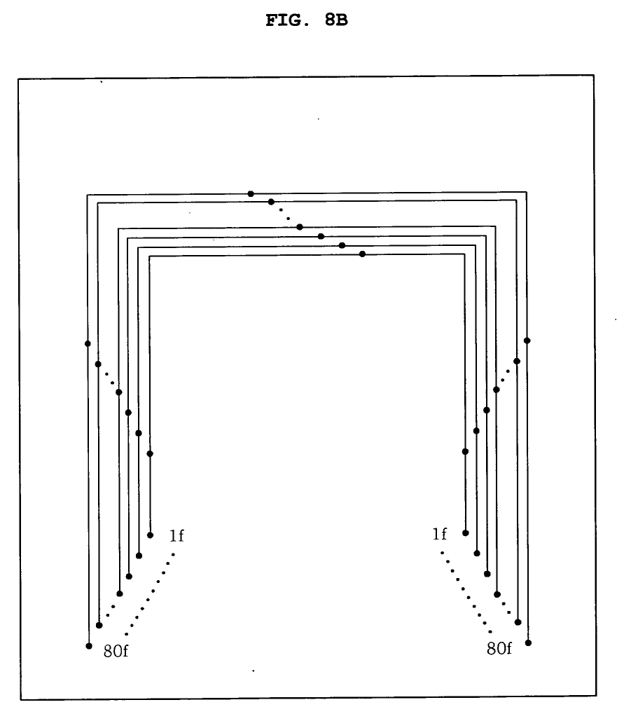

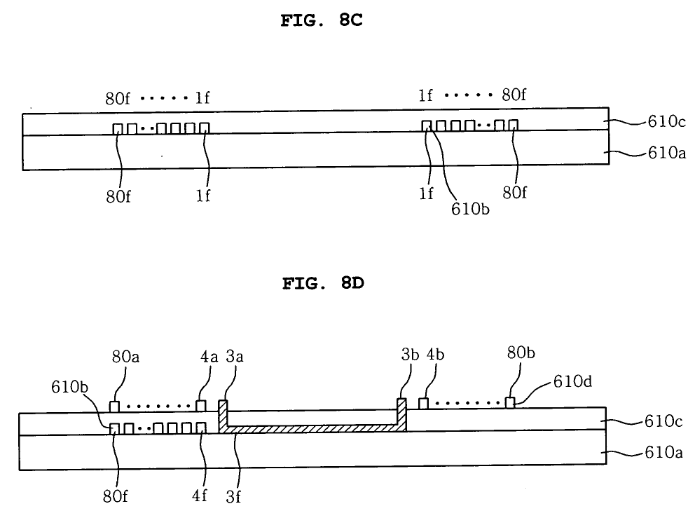

FIGS. 8A and 8B are plan views to illustrate the wiring of the transparent substrate of FIG. 6, and FIGS. 8C and 8D are sectional views to illustrate the wiring of the transparent substrate of FIG. 6.

For an easy description of this invention, the position of the connector is slightly changed in FIGS. 8A to 8D. The drawings show an example where the wiring is formed in a two-layered structure. Therefore, compact wiring is possible.

Referring to FIG. 8A, assuming that the number of signal lines coming out of the electronic control circuits 630a to 630d is 80, the electronic control circuit 630a has signal lines 1a to 80a, the electronic control circuit 630b has signal lines 1b to 80b, the electronic control circuit 630c has signal lines 1c to 80c, and the electronic control circuit 630d has signal lines 1d to 80d. In this case, the number of signal lines input from the external control circuit is 80, so that 80 signal lines must be connected to the connector 640. The signal lines of the connector 640 are denoted by 1e to 80e.

As shown in FIG. 8A, the outermost signal line is the longest, and the length of the signal lines is reduced in a direction from the outermost position to the innermost position. Further, signal lines of neighboring electronic control circuits 630a and 630b, 630c and 630d are symmetrical with respect to each other.

A via hole is formed at an end point of each signal line to be electrically connected to the wiring of a lower layer of FIG. 8B.

FIG. 8B is a plan view of the lower layer of the transparent substrate 610. As shown in the drawing, the wiring is arranged in a U shape. The points of the drawing show the connection of the signal lines of the upper layer with the wiring of the lower layer through the via holes.

FIG. 8C is a sectional view taken along line A-A′ of FIG. 8A. A circuit layer 610b having the wiring of FIG. 8B is formed on the lower layer 610a of the transparent substrate 610, and an insulation layer 610c is formed on the circuit layer 610b so that the wiring of the lower layer is electrically insulated from the signal lines of the upper layer except for the via holes.

FIG. 8D is a sectional view taken along line B-B′ of FIG. 8A, showing the internal wiring in detail. That is, a third signal line 3a of the electronic control circuit 630a of the upper layer is connected to a third wiring 3f of the lower layer through the via hole. Further, a third signal line 3b of the electronic control circuit 630b of the upper layer is connected to the third wiring 3f of the lower layer through the via hole.

In this case, the wiring 3f of the lower layer is electrically connected to the wiring of the upper layer having the connector 640 through the via hole. The wiring of the upper layer is electrically connected to the connector 640.

As described above, the present invention allows a light, thin, compact, and small optical modulator product to be efficiently manufactured.

Further, the present invention provides an optical modulator having superior heat dissipation efficiency.

This invention realizes the manufacture of an optical modulator while maintaining optical properties of an optical modulating device and preventing degradation of the optical properties during the modularizing process.

Further, the present invention makes optical alignment easy when the module is mounted in a display unit.

Furthermore, this invention provides a package structure for an optical modulator, which allows a drive signal to be easily applied.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A package structure for an optical modulator, comprising:
a transparent substrate;
an optical modulating device disposed on the transparent substrate;
electronic circuitry for controlling the optical modulating device, said electronic circuitry disposed on the transparent substrate;
a printed circuit board on which the transparent substrate is disposed, said printed circuit board configured to permit light to pass into the package structure to the optical modulating device and to permit light to pass from the optical modulating device out though the package structure; and
an electrical connection system electrically interconnecting the optical modulating device, the electronic control circuitry, and the printed circuit board.

2. The package structure according to claim 1, wherein the electrical connection system comprises:
a first subsystem interconnecting the optical modulating device and the electronic control circuitry, said first subsystem integrated into the transparent substrate; and
a second subsystem interconnecting the optical modulating device and the electronic control circuitry with the printed circuit board.

3. The package structure according to claim 2, wherein the second electrical connection subsystem incorporates the transparent substrate.

4. The package structure according to claim 1, wherein said optical modulating device is positioned relative to the transparent substrate so that light is transmitted through the transparent substrate to the optical modulating device and light is transmitted through the substrate from the optical modulating device.

5. The package structure according to claim 1, wherein the optical modulating device comprises:
components that are controlled by the electronic control circuitry to move towards or away from the transparent substrate.

6. The package structure according to claim 1, wherein the optical modulating device is mounted on the transparent substrate by flip-chip bonding, and the electronic control circuitry is also mounted on the transparent substrate by flip-chip bonding.

7. The package structure according to claim 1, further comprising:
a sealant creating a hermetic seal between the optical modulating device and the transparent substrate.

8. The package structure according to claim 1, wherein the second electrical connection subsystem comprises wire bonding connections.

9. The package structure according to claim 1, wherein at least one opening is provided in the printed circuit board to allow light to pass therethrough to and from the optical modulating device.

10. The package structure according to claim 1, further comprising:
an external electrical connector electrically connecting the printed circuit board to an exterior.

11. The package structure according to claim 1, further comprising:
a heat conductive structure disposed in heat transmission relationship to at least one of the optical modulating device and electrical control circuitry so as to dissipate heat from the optical modulating device and/or the electrical control circuitry.

12. The package structure according to claim 1, further comprising:
molding to surround and encase the transparent substrate, the optical modulating device, and the electrical control circuitry.

13. A package structure for an optical modulator, comprising:
a transparent substrate;
an optical modulating device disposed on the transparent substrate;
electronic circuitry for controlling the optical modulating device, said electronic circuitry disposed on the transparent substrate; and
an electrical connection system extending between the optical modulating device and the electronic control circuitry, said electrical connection system incorporated into the transparent substrate.

14. The package structure according to claim 13, wherein said optical modulating device is positioned relative to the transparent substrate so that light is transmitted through the transparent substrate to the optical modulating device and light is transmitted through the substrate from the optical modulating device.

15. The package structure according to claim 13, wherein the optical modulating device comprises:
components that move in a direction towards or away from the transparent substrate during operation of the optical modulating device.

16. The package structure according to claim 13, wherein the optical modulating device comprises:
components that are controlled by the electronic control circuitry to move towards or away from the transparent substrate.

17. The package structure according to claim 13, wherein the optical modulating device is mounted on the transparent substrate by flip-chip bonding, and the electronic control circuitry is also mounted on the transparent substrate by flip-chip bonding.

18. The package structure according to claim 13, further comprising:
a sealant creating a hermetic seal between the optical modulating device and the transparent substrate.

19. The package structure according to claim 13, further comprising:
a printed circuit board on which the transparent substrate is disposed; and
a second electrical connection system connecting the printed circuit board and the transparent substrate.

20. The package structure according to claim 19, wherein the second electrical connection system comprises wire bonding connections.

21. The package structure according to claim 19, wherein the printed circuit board is configured to allow light to pass into the package structure to the optical modulating device and to permit light to pass from the optical modulating device out through the package structure.

22. The package structure according to claim 21, wherein at least one opening is provided in the printed circuit board to allow light to pass therethrough to and from the optical modulating device.

23. The package structure according to claim 19, further comprising:
an external electrical connector to electrically connect the printed circuit board to an exterior.

24. The package structure according to claim 13, further comprising:
an external electrical connector to electrically connect the transparent substrate to an exterior.

25. The package structure according to claim 13, further comprising:
a heat conductive structure disposed in heat transmission relationship to at least one of the optical modulating device and electrical control circuitry so as to dissipate heat from the optical modulating device and/or the electrical control circuitry.

26. The package structure according to claim 13, further comprising:
molding to surround and encase the transparent substrate, the optical modulating device, and the electrical control circuitry.
